(19) United States
(12) Patent Application Publication
(10) Pub. No.: US 2008/0296435 A1
(43) Pub. Date: Dec. 4, 2008

(54) Shear-thickening fluid reinforced fabrics for use with an expandable spacecraft

(75) Inventor: Dan Cohen, Las Vegas, NV (US)

Correspondence Address: Franklin E. Gibbs, Esq., 1899 W. Brooks Ave., North Las Vegas, NV, 89032, US

(73) Assignee: Bigelow Aerospace

(21) Appl. No.: 11/807,830

(22) Filed: May 30, 2007

(51) Int. Cl. B64G 1/22

(52) U.S. Cl. 244/158.3

(57) ABSTRACT

A shear-thickening fluid is used in conjunction with fabrics utilized in an expandable spacecraft. The combination of the fluid and the fabric allows the fabric to resist penetration by hypervelocity particles in space.

### BACKGROUND OF THE INVENTION

1. Field of the Invention

The present invention relates to the use of a shear-thickening fluid (STF) to reinforce fabrics utilized in an expandable spacecraft. In particular, the STF infused fabrics exhibits characteristics that are useful as a micro meteor orbital debris (MMOD) shield.

2. Description of Related Art

Inflatable, or expandable, spacecraft are known generally in the art as evidenced by U.S. Pat. Nos. 6,231,010 to Schneider, et al and 6,547,189 to Raboin, et al. These types of habitable structures have the unique ability to change states from a compressed launch state to an inflated deployed state. In the deployed state, the structure provides an internal volume that is many times greater than the volume found in the launch state.

Usually an inflatable craft has multiple flexible layers. For example, an air barrier layer to retain an atmosphere, a restraint layer to contain the air barrier, and a protective MMOD layer. During deployment of the spacecraft an atmosphere suitable to support humans is injected into the structure, or module, to facilitate inflation.

The MMOD is the layer principally responsible for preventing space debris from penetrating the module. The MMOD has a number of spaced flexible shield layers that act to disperse hypervelocity particles on impact. Kinetic energy is transferred by the particles to each impacted layer causing a reduction of the velocity of the particles while dispersing the shocked particles. Optimally, the resulting dispersed particles are too small and traveling too slowly to fully penetrate the MMOD shield.

While the MMOD shield provides a level of protection against penetration of the module by hypervelocity impactors, it is desirable for other layers of the module to also have the ability to inhibit penetration of the module by space debris. It is desirable to find a way to increase the resistance to penetration of, for example, the restraint layer to impacting particles.

Recent developments in material science have led to the development of a new class of advanced composite materials classified as shear-thickening fluid (STF) fabrics. It is best described as a rate sensitive micro-cellular composite, incorporating ‘intelligent’ molecules. The molecules are free flowing when movement is normal, providing a soft and flexible material. However, when impact occurs (representing a condition with high shear forces), the molecules lock together making the material stiffen, absorbing impact energy.

Polyethylene glycol based STFs comprised of, for example, stabilized spherical colloidal silica (such as MP4540 from Nissan Chemicals) and polyethylene glycol are known in the art and have been applied to such applications as body armor. However, body armor is designed to respond to projectiles that do not reach the high speeds of hypervelocity particles in space and body armor is not designed to operate in a space environment.

The characteristics of space (e.g., extreme temperature swings, vacuum, low gravity, etc.) presents a setting that is unique to the application of STF materials. The STFs must be chosen to function in space with an acceptable level of degradation over time due to, for example, exposure to a vacuum, radiation, and atomic oxygen. Further, the STFs must operate over a wide temperature range.

What is needed is an STF tailored to space applications where the STF could be used in conjunction with, as an example, the restraint layer to provide another measure of protection against penetration of a space deployed module by hypervelocity particles.

### BRIEF SUMMARY OF THE INVENTION

One aspect of the present invention is to provide a measure of protection against penetrations of a layer material of an inflatable module by hypervelocity particles. Another aspect of the present invention is directed toward a layer material that is impregnated with a shear thickening fluid. The impregnated layer material provides a measure of protection against hypervelocity impactors from penetrating the impregnated material that is greater than the protection afforded by a layer material without the shear thickening fluid. Another aspect of the present invention focuses on the impregnated layer material being attached to the core of an inflatable module. Still another aspect of the present invention is impregnating the restraint layer of an inflatable module to resist penetrations by hypervelocity objects. Yet another aspect of the present invention is to deploy the modules where layers are impregnated with shear thickening fluid into space or onto extraterrestrial masses such as the Moon.

### BRIEF DESCRIPTION OF THE SEVERAL VIEWS OF THE DRAWINGS

FIG. 1 is a cross sectional view of a material impregnated with a shear-thickening fluid.

FIG. 2 is a cross sectional view of a material impregnated with a shear-thickening fluid under stress.

FIG. 3 is a partial cutaway view of an inflatable spacecraft.

### DETAILED DESCRIPTION OF THE INVENTION

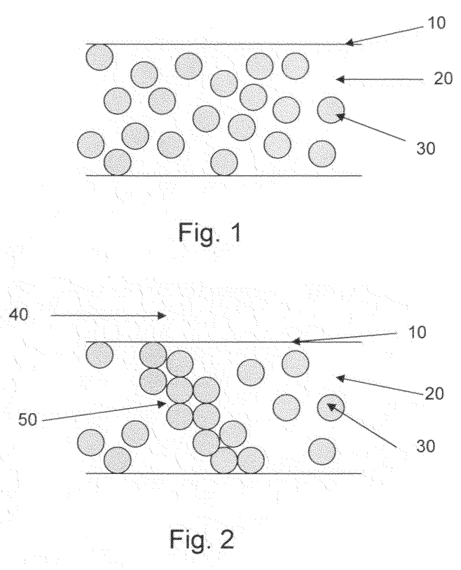

Referring to FIG. 1, a strap 10 is impregnated with a fluid 20 containing rigid colloidal particles 30. The strap 10 can be composed of materials that exhibit the ability to resist penetration by rapidly moving objects. The strap 10 can also have other preferable characteristics depending upon the application. For example, the strap 10 may be part of a restraint layer of an inflatable spacecraft where is it necessary for the strap 10 to resist tearing due to the pressure exerted by the internal volume of the craft. In the preferred embodiment, the strap is composed of Kevlar®. While a strap is identified as a preferred embodiment, a strap is just one type of a broader category of layer materials that can be incorporated into an inflatable spacecraft.

A fluid 20 such as ethylene glycol containing rigid colloidal particles 30, such as particles of silica, is impregnated into the strap 10 by known techniques. As FIG. 1 illustrates, the particles 30 are dispersed throughout the strap 10. The impregnation can be done on filaments, threads, or even a fully formed strap 10 having numerous threads as components. The combination of the fluid 10 and particles 30 form what is generally known to be a shear-thickening fluid (STF).

The choice of fluid 20 and particles 30 is dependent upon numerous factors such as, but not limited to, the estimated size and speed of impactors, and temperature and radiation from the environment where the craft is deployed. For example, the particles may be a mix of silica and ceramic materials, or each particle may be comprised of silica and a metal. Also, ethylene glycol may be substituted for a medium such as polyethylene glycol.

It is not unusual for high velocity space debris and/or particles to exceed speeds of one thousand meters per second. In practice, the choice of an STF and layer material combination would be dependent upon mathematical models established to predict the outcome of such high velocity impacts as well as test data obtained though high velocity impact testing.

Turning to FIG. 2, when a shear stress 40 in applied to the strap 10, hydroclusters 50 form. The hydroclusters 50 become rigid and the strap 10 is more resistant to penetration than without the STF. The direction of the shear stress 40 in FIG. 2 is merely representative and not intended as a limitation as to the direction of the stress. The transition to a shear thickening state of hydroclusters 50 is stress dependent. As would be expected, impact with a hypervelocity particle would require a quick transition rate to effectuate a resistance to penetration. The transition rate is thus one factor that would drive the choice of an STF in application. One aspect of the present invention is the choice of an STF where the application of an electric field, magnetic field, or a controlled directed force could induce the development of hydroclusters before a hypervelocity impact. In this embodiment the deployed inflated spacecraft would not exhibit a rigid layer material until the application of the field or force that would impose a transition on the layer material.

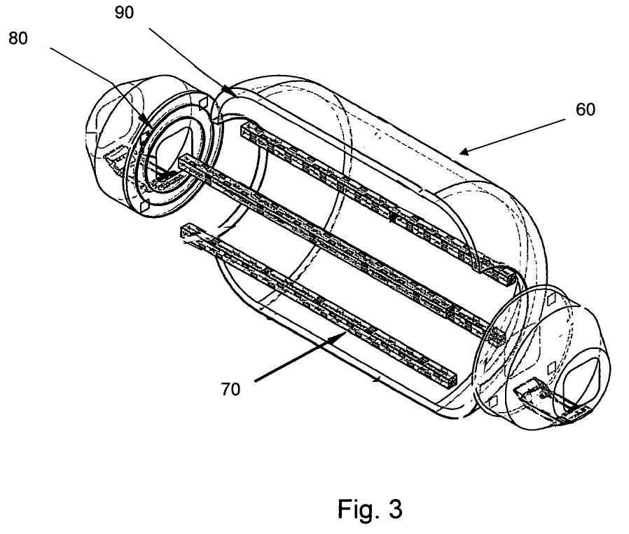

Addressing FIG. 3, an inflatable spacecraft 60 is depicted. Longerons 70 connect two opposing airlocks 80. The combination of the longerons 70 and the airlocks 80 compose the core of an inflatable spacecraft. A restraint layer 90 is attached to each of the airlocks 80. In this fashion, the restraint layer 90 is attached to the core of the expandable spacecraft. The restraint layer 90 is a plurality of straps as identified in FIG. 3 where the straps are impregnated with a STF. Usually, an (MMOD) layer would de deployed over the restraint layer. An advantage to the STF impregnated strap is that any particles that penetrate the MMOD would impact a reinforced strap that could substantially reduce potential penetrations into the interior of the module.

It is possible to impregnate other layers of the inflatable spacecraft such as any fabric layers of an MMOD. Also, it is possible to use the STF as a layer between other layers of materials.

There has thus been described a novel combination and application of a shear-thickening fluid and fabric materials as part of an inflatable spacecraft. It is important to note that many configurations can be constructed from the ideas presented. The foregoing disclosure and description of the invention is illustrative and explanatory thereof and thus, nothing in the specification should be imported to limit the scope of the claims. Also, the scope of the invention is not intended to be limited to those embodiments described and includes equivalents thereto. It would be recognized by one skilled in the art the following claims would encompass a number of embodiments of the invention disclosed and claimed herein.

What is claimed is:

1. An inflatable space module core and reinforced layer structure comprising;
A layer material;
a shear thickening fluid;
a core of an inflatable space module;
the layer material being impregnated with the shear thickening fluid such that the impregnated layer material provides a measure of protection against hypervelocity impactors that is greater than the protection afforded by a layer material without the shear thickening fluid, and;
the impregnated layer material being attached to the core of an inflatable space module.

2. The inflatable space module core and reinforced layer structure of claim 1 wherein the layer material is a restraint layer.

3. An inflatable space module core and restraint layer system comprising;
A restraint layer fabric;
a shear thickening fluid;
a core of an inflatable space module;
the restraint layer fabric being impregnated with the shear thickening fluid such that the impregnated restraint layer fabric provides a measure of protection against hypervelocity impactors that is greater than the protection afforded by a restraint layer fabric without the shear thickening fluid, and;
the impregnated restraint layer fabric being attached to the core of an inflatable space module.

4. The inflatable space module core and restraint layer system of claim 1 wherein the inflatable space module core and restraint layer system is deployed on an extraterrestrial mass.

5. A process for producing an inflatable space module core and restraint material structure comprising;
impregnating a restraint material with a shear thickening fluid; and
attaching the impregnated restraint material to the core of an inflatable space module.

6. The reinforced layer used in connection with an inflatable space module of claim 4 wherein the inflatable space module and reinforced layer is deployed on an extraterrestrial mass.
